(19) United States
(12) Patent Application Publication
(10) Pub. No.: US 2011/0037657 A1
(43) Pub. Date: Feb. 17, 2011

(54) MULTIBAND ANTENNA AND ANTENNA ASSEMBLY

(75) Inventor: CHIH-YUAN YANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/614,451

(22) Filed: Nov. 9, 2009

(30) Foreign Application Priority Data
Aug. 14, 2009 (CN) 200910305605.0

(51) Int. Cl. H01Q 1/38; H01Q 9/04

(52) U.S. Cl. 343/700 MS

(57) ABSTRACT

A multiband antenna includes a first conductive sheet, a second conductive sheet, and a feeding point. The second conductive sheet is a square sheet defining a cutout on a side thereof. The first conductive sheet is square, and includes a first side, a second side, a third side, and a fourth side connected in sequence. The first conductive sheet is received in the cutout and separated from the second conductive sheet. The feeding point is formed on the fourth side of the first conductive sheet facing away from the second conductive sheet.

### BACKGROUND

1. Technical Field

The present disclosure relates to antennas and, particularly, to a multiband antenna and an antenna assembly having the same.

2. Description of Related Art

Antennas are usually designed to work with a particular wireless access technology in mind. Cellular telephones, for example, contain antennas that are used to handle radio-frequency communications with cellular base stations. Handheld computers often include short-range antennas for handling wireless connections with wireless access points. Global positioning system (GPS) devices typically contain antennas that are designed to operate at GPS frequencies.

Thus, in order to operate with multiband signals, electronic devices usually must include a number of antennas to accommodate different frequencies. However, as the number of antennas increases this may limit the miniaturization of the electronic device.

What is needed, therefore, is a multiband antenna to overcome or at least mitigate the above-described problem.

### BRIEF DESCRIPTION OF THE DRAWINGS

Many aspects of the present multiband antenna and antenna assembly can be better understood with reference to the accompanying drawings. The components in the drawings are not necessarily drawn to scale, the emphasis instead being placed upon clearly illustrating the principle of the present multiband antenna and antenna assembly. In the drawings, all the views are schematic.

FIG. 1 is a schematic view of an antenna assembly according to an exemplary embodiment.

FIG. 2 is a top plan view of the antenna assembly of FIG. 1.

FIG. 3 is a schematic diagram showing the return loss versus frequency characteristic of the antenna assembly of FIG. 1.

### DETAILED DESCRIPTION

Embodiments of the present disclosure will now be described in detail below, with reference to the accompanying drawings.

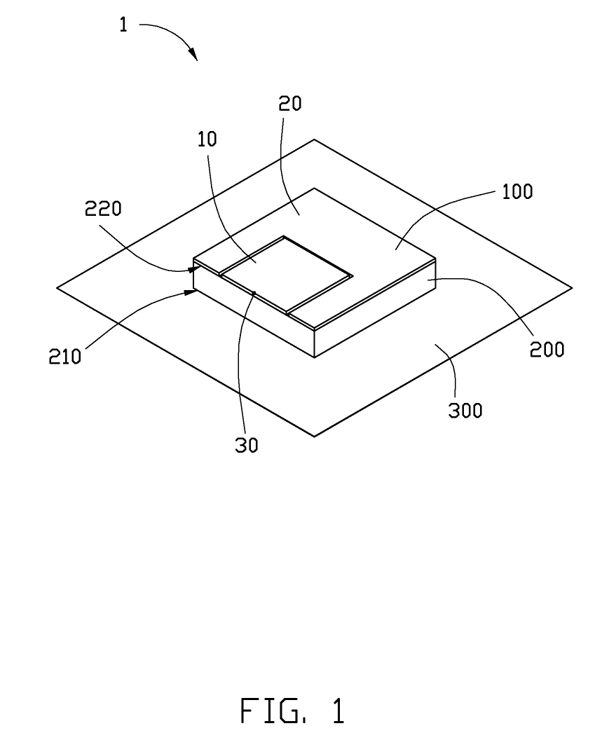

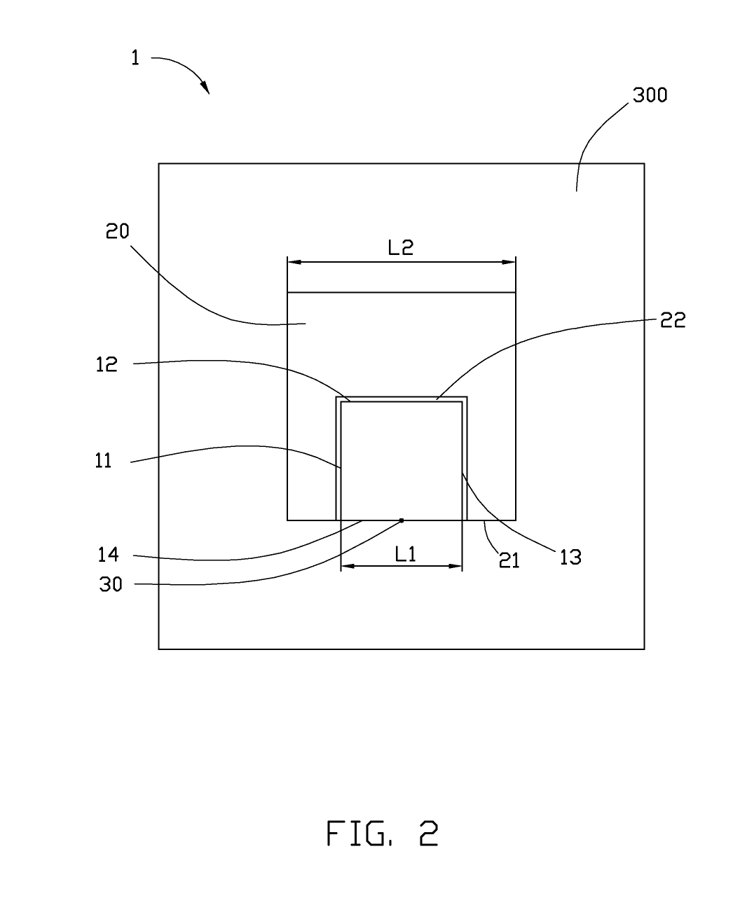

Referring to FIGS. 1 and 2, an antenna assembly 1 according to an exemplary embodiment, is shown. The antenna assembly 1 includes a multiband antenna 100, an insulating board 200, and a grounding board 300. The antenna assembly 1 can be assembled in a mobile phone and a personal digital assistant etc.

The multiband antenna 100 includes a first conductive sheet 10, a second conductive sheet 20, and a feeding point 30.

The first conductive sheet 10 is square. The first conductive sheet 10 includes a first side 11, a second side 12, a third side 13, and a fourth side 14, which are connected in sequence. The first conductive sheet 10 is capable of operating under a first frequency. The first frequency satisfies the following expression:

$${L}_{1} = \frac{3 \times {10}^{8}}{2 \times ( {f}_{1} \times \sqrt{ɛ} )} ,$$

wherein, L₁ is the side-length of the first conductive sheet 10, f₁ is the first frequency, and ∈ is the dielectric constant of the first conductive sheet 10. In the present embodiment, L₁ is equal to 5.89 cm, ∈ is equal to 4.5, and f is equal to 2.4 GHz.

The second conductive sheet 20 is a square sheet defining a cutout 22 on a side 21 thereof. The size of the cutout 22 is a little bigger than the size of the first conductive sheet 10. The first conductive sheet 10 is received in the cutout 22 of the second conductive sheet 20, and is separated from the second conductive sheet 20. The fourth side 14 of the first conductive sheet 10 faces away from the second conductive sheet 20. The fourth side 14 of the first conductive sheet 10 and the side 21 of the second conductive sheet 20 are substantially arranged on a line. In the present embodiment, the cutout 22 is square-shaped. The first side 11, the second side 12, and the third side 13 face the second conductive sheet 20, and have a same distance from the second conductive sheet 20. The first conductive sheet 10 and the second conductive sheet 20 as a whole is capable of operating under a second frequency. The second frequency satisfies the following expression:

$${L}_{2} = \frac{3 \times {10}^{8}}{2 \times ( {f}_{2} \times \sqrt{ɛ} )} ,$$

wherein, L₂ is the side-length of the second conductive sheet 20, f₂ is the second frequency, and ∈ is the dielectric constant of the first conductive sheet 10 and the second conductive sheet 20. In the present embodiment, L₂ is equal to 8.98 cm, ∈ is equal to 4.5, and f₂ is equal to 1.575 GHz.

The feeding point 30 is formed on the fourth side 14 of the first conductive sheet 10. In the present embodiment, the feeding point 30 is formed in the center of the fourth side 14.

The insulating board 200 has a first surface 210 and a second surface 220. The first surface 210 and the second surface 220 are located at two opposite sides of the insulating board 200. The first conductive sheet 10 and the second conductive sheet 20 are attached to the second surface 220 of the insulating board 200. The grounding board 300 is attached to the first surface 210 of the insulating board 200. In the present embodiment, the insulating board 200 is a print circuit board.

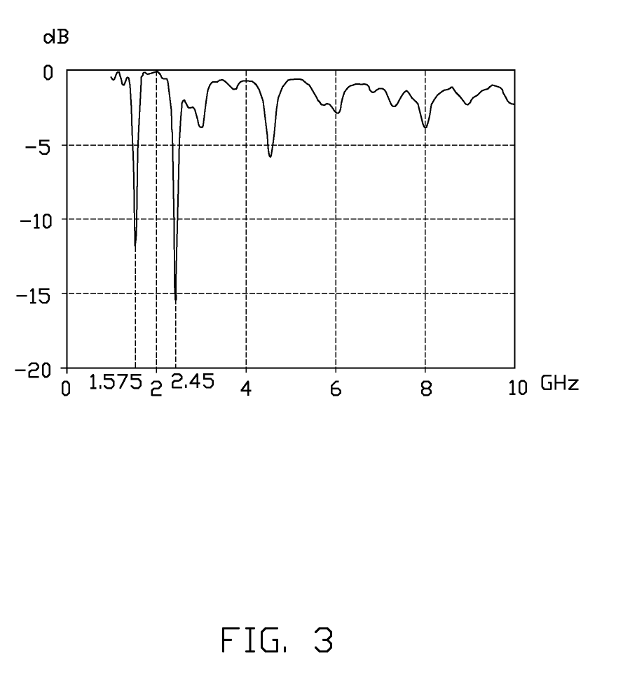

In the present embodiment, the first conductive sheet 10 is capable of operating under a first frequency 2.4 GHz for receiving or radiating Institute of Electrical and Electronics Engineers, Inc. (IEEE) 802.11 wireless standard (802.11) signals. The first conductive sheet 10 and the second conductive sheet 20 as a whole is capable of operating under a second frequency 1.575 GHz for receiving or radiating GPS signals. Referring to FIG. 3, the antenna 100 achieves a return loss smaller than −10 dB at approximately 1.575 GHz, which is the second frequency for receiving or radiating GPS signals. The multiband antenna 100 achieves a return loss smaller than −15 dB at approximately 2.4 GHz, which is the first frequency for receiving or radiating IEEE 802.11 signals. Therefore, the multiband antenna 100 can operate under two frequencies for receiving or radiating IEEE 802.11 and GPS signals.

While certain embodiments have been described and exemplified above, various other embodiments will be apparent to those skilled in the art from the foregoing disclosure. The invention is not limited to the particular embodiments described and exemplified, and the embodiments are capable of considerable variation and modification without departure from the scope and spirit of the appended claims.

What is claimed is:

1. A multiband antenna comprising:
a first conductive sheet comprising a first side, a second side, a third side, and a fourth side connected in sequence, the first conductive sheet being square;
a second conductive sheet, the second conductive sheet being a square sheet defining a cutout on a side thereof, the first conductive sheet being received in the cutout and separated from the second conductive sheet; and
a feeding point formed on the fourth side of the first conductive sheet facing away from the second conductive sheet.

2. The multiband antenna of claim 1, wherein the first conductive sheet is capable of operating under a first frequency, the first frequency satisfies the following expression:
$${L}_{1} = \frac{3 \times {10}^{8}}{2 \times ( {f}_{1} \times \sqrt{ɛ} )} ,$$
wherein L₁ is the side-length of the first conductive sheet, f₁ is the first frequency, and ∈ is the dielectric constant of the first conductive sheet.

3. The multiband antenna of claim 2, wherein the first frequency is substantially equal to 2.4 GHz.

4. The multiband antenna of claim 1, wherein the cutout of the second conductive sheet is square-shaped.

5. The multiband antenna of claim 1, wherein the fourth side of the first conductive sheet and the side of the second conductive sheet with the cutout defined thereon are substantially arranged on a line.

6. The multiband antenna of claim 5, wherein the first side, the second side, and the third side of the first conductive sheet face the second conductive sheet, and have a same distance from the second conductive sheet.

7. The multiband antenna of claim 1, wherein the first conductive sheet and the second conductive sheet as a whole is capable of operating under a second frequency, the second frequency satisfies the following expression:
$${L}_{2} = \frac{3 \times {10}^{8}}{2 \times ( {f}_{2} \times \sqrt{ɛ} )} ,$$
wherein, L₂ is the side-length of the second conductive sheet, f₂ is the second frequency, and ∈ is the dielectric constant of the first conductive sheet and the second conductive sheet.

8. The multiband antenna of claim 7, wherein the second frequency is substantially equal to 1.575 GHz.

9. The multiband antenna of claim 1, wherein the feeding point is formed in the center of the fourth side of the first conductive sheet.

10. An antenna assembly comprising:
an insulating board comprising a first surface and a second surface opposite to the first surface;
a grounding board attached to the first surface of the insulating board; and
a multiband antenna attached to the second surface of the insulating board, the multiband antenna comprising:
a first conductive sheet comprising a first side, a second side, a third side, and a fourth side connected in sequence, the first conductive sheet being square;
a second conductive sheet, the second conductive sheet being a square sheet defining a cutout on a side thereof, the first conductive sheet being received in the cutout and separated from the second conductive sheet; and
a feeding point formed on the fourth side of the first conductive sheet facing away from the second conductive sheet.

11. The antenna assembly of claim 10, wherein the first conductive sheet is capable of operating under a first frequency, the first frequency satisfies the following expression:
$${L}_{1} = \frac{3 \times {10}^{8}}{2 \times ( {f}_{1} \times \sqrt{ɛ} )} ,$$
wherein L₁ is the side-length of the first conductive sheet, f₁ is the first frequency, and ∈ is the dielectric constant of the first conductive sheet.

12. The antenna assembly of claim 11, wherein the first frequency is substantially equal to 2.4 GHz.

13. The antenna assembly of claim 10, wherein the cutout of the second conductive sheet is square-shaped.

14. The antenna assembly of claim 10, wherein the fourth side of the first conductive sheet and the side of the second conductive sheet with the cutout defined thereon are substantially arranged on a line.

15. The antenna assembly of claim 14, wherein the first side, the second side, and the third side of the first conductive sheet face the second conductive sheet, and have a same distance from the second conductive sheet.

16. The antenna assembly of claim 10, wherein the first conductive sheet and the second conductive sheet as a whole is capable of operating under a second frequency, the second frequency satisfies the following expression:
$${L}_{2} = \frac{3 \times {10}^{8}}{2 \times ( {f}_{2} \times \sqrt{ɛ} )} ,$$
wherein, L₂ is the side-length of the second conductive sheet, f₂ is the second frequency, and ∈ is the dielectric constant of the first conductive sheet and the second conductive sheet.

17. The antenna assembly of claim 16, wherein the second frequency is substantially equal to 1.575 GHz.

18. The antenna assembly of claim 10, wherein the feeding point is formed in the center of the fourth side of the first conductive sheet.

19. The antenna assembly of claim 10, wherein the insulating board is a print circuit board.
